(19) United States
(12) Patent Application Publication
(10) Pub. No.: US 2003/0100652 A1
(43) Pub. Date: May 29, 2003

(54) Diene copolymers substituted with polar polysiloxane groups and nanocomposites manufactured therefrom

(75) Inventors: Eun Kyoung Kim, Yusung-ku (KR); Mijeong Han, Yusung-ku (KR)

Correspondence Address: Finnegan, Henderson, Farabow,, Garrett & Dunner, L.L.P., 1300 I Street, N.W., Washington, DC, 20005-3315, US

(73) Assignee: Korea Research Institute of Chemical Technology

(21) Appl. No.: 10/244,447

(22) Filed: Sep. 17, 2002

(30) Foreign Application Priority Data
Sep. 18, 2001 (KR) 2001-57443

(51) Int. Cl. C08K 3/18

(52) U.S. Cl. 524/430; 526/345; 525/342; 524/493; 524/495

(57) ABSTRACT

Disclosed is a diene copolymer substituted with polar polysiloxane of the following formula 1 and nanocomposites manufactured therefrom,

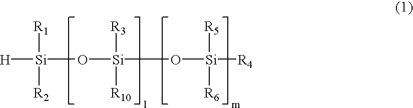

wherein the above formula 1, R₁, R₂, R₃, R₅ and R₆ are independently the same or different substitution group of a methyl group or a phenyl group; R₄ is —(CH₂)ₙ—(R₇)—(R₈O)ₚ—R₉; R₇ represents a bond, —O—, a substituted or unsubstituted alkylene group of C₁-C₅ or a benzene ring; R₈ is —(CH₂)₂— or —CH (CH₃) CH₂—, R₉ represents a substituted or unsubstituted alkyl group of C₁-C₂₀, a halogen atom, —COCH₃ or —SO₂CH₃; R₁₀ is the same as R₄ or a methyl group or a phenyl group; l is an integer of 0-50; m is an integer of 1-500; n is an integer of 2-5; and p is an integer of 0-100. The modified diene copolymer substituted with polar polysiloxane of the present invention can be used as a modifying agent, a binder, a dispersing agent, a composite of various polymers, and in particular, they can have excellent mechanical strength, weatherability, and transparency if they are manufactured into a composite by combining with an inorganic filler.

### FIELD OF THE INVENTION

The present invention relates to diene copolymers substituted with polar polysiloxane of the following formula 1 and nanocomposites manufactured therefrom,

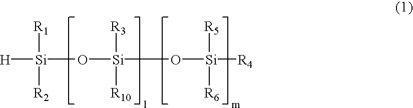

wherein R₁, R₂, R₃, R₅ and R₆ are independently the same or different substitution group of a methyl group or a phenyl group; R₄ is —(CH₂)ₙ—(R₇)—(R₈O)ₚ—R₉; R₇ represents a bond, —O—, a substituted or unsubstituted alkylene group of C₁-C₅ or a benzene ring; R₈ is —(CH₂)₂— or —CH (CH₃) CH₂—; R₉ represents a substituted or unsubstituted alkyl group of C₁-C₂₀, a halogen atom, —COCH₃ or —SO₂CH₃; R₁₀ is the same as R₄ or a methyl group or a phenyl group; l is an integer of 0-50; m is an integer of 1-500; n is an integer of 2-5; and p is an integer of 0-100. The modified diene copolymers substituted with polar polysiloxane of the present invention can be used as a modifying agent, a binder, a dispersing agent, a composite of various polymers, and in particular, they have excellent mechanical strength, weather resistance and transparency when they are manufactured into a composite by adding an inorganic filler.

### BACKGROUND OF THE INVENTION

Elastomers are easy to synthesize, have excellent mechanical strength and elasticity and are thus widely used as an adhesive, automobile parts, shock absorbing agents, shoes, packing, and the like. Moreover, there are also developed organic-inorganic hybrid elastomer composites in which silica and glass fiber are added to improve heat resistance and strength of elastomers. For example, Korea Pat. No. 108956 discloses a styrene-based resin composition comprising 0.3-1.0 parts by wt of polysiloxane and glass fiber relative to 100 parts by wt of styrene resin, which comprises 20-70 parts by wt of non-crystalline polystyrene resin and 80-30 parts by wt of rubber modified polystyrene resin. The above patent relates to an organic polymer composite manufactured by dispersing polysiloxane in styrene resin, however, it has drawbacks that there easily occurs a phase separation due to the absence of chemical bonding between polysiloxane and a polymer, and further, it is hard to improve physical properties of a given composite because the organic polymer is not compatible with an inorganic filler. Therefore, numerous studies have been focused on developing resins having a substituted siloxane group in a polymer to impart an improved miscibility with an inorganic filler as well as improved compatibility between polysiloxane and a polymer. For example, poly(isoprene) block copolymer (PS-b-PDPI) substituted with pentamethyl disiloxane was disclosed [Gabor, Allen H.; Lehner, Eric A.; Mao, Guoping; Schneggenburger, Lizabeth A.; Ober, Christopher K., Chem. Mater. (1994), 6(7), 927□34], however, the above copolymer was shown to have a low compatibility with an inorganic filler due to the absence of a polar group in the siloxane itself, such as an alkoxy group or a polyethylene glycol.

### SUMMARY OF THE INVENTION

In order to solve the above-mentioned problems, the inventors of the present invention conducted extensive studies on the method of manufacturing diene copolymers substituted with polar polysiloxane with a particular structure having a polar group, and more particularly, on the hydrosilylation reaction of polar siloxane comprising a block copolymer and a silane group. As a result, the inventors succeeded in manufacturing a newly modified diene copolymer with a substituted polar polysiloxane, wherein said newly modified diene copolymer has an increased interaction with organically modified montmorillonite (OMMT) thus enabling to manufacture nanocomposites having improved tensile strength, transparency, elasticity, and the like.

Therefore, the object of the present invention is to provide diene copolymers substituted with polar polysiloxane by reacting said reactive polysiloxane with a diene copolymer in the presence of a catalyst.

Another object of the present invention is to provide nanocomposites comprising said modified diene copolymer and an inorganic filler.

### BRIEF DESCRIPTION OF THE DRAWINGS

FIG. 1 is representative XRD spectra and representing the distance between the layers of a nanocomposite of modified SBS (PEGPDMS-SBS)/OMMT shown in example 2.

(a) nanocomposites of PEGPDMS-SBS/OMMT

(b) OMMT alone (6A)

### DETAILED DESCRIPTION OF THE INVENTION

The present invention relates to a modified diene copolymer having number average molecular weight of 400-100,000 wherein a diene copolymer is substituted with polar polysiloxane of the following formula 1 via hydrosilylation.

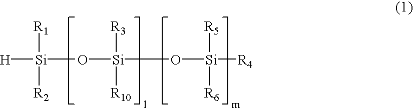

wherein R₁, R₂, R₃, R₅ and R₆ are independently the same or different substitution group of a methyl group or a phenyl group; R₄ is —(CH₂)ₙ—(R₇)—(R₈O)ₚ—R₉; R₇ represents a bond, —O—, a substituted or unsubstituted alkylene group of C₁-C₅ or a benzene ring; R₈ is —(CH₂)₂— or —CH(CH₃)CH₂—, R₉ represents a substituted or unsubstituted alkyl group of C₁-C₂₀, a halogen atom, —COCH₃ or —SO₂CH₃; R₁₀ is the same as R₄ or a methyl group or a phenyl group; l is an integer of 0-50; m is an integer of 1-500; n is an integer of 2-5; and p is an integer of 0-100.

The present invention also relates to a nanocomposite comprising the above-mentioned modified diene copolymer and at least one kind of inorganic filler selected from the group consisting of silica, carbon black, metal powder, metal oxide, layered-silicate, glass fiber, and ceramic.

The present invention is described in more detail as set forth hereunder.

The polysiloxane of the following formula 1, which is used as a modifying agent in manufacturing the modified diene copolymer of the present invention, is manufactured via a known method of reacting a polysiloxane substituted with a hydrogen atom, as represented by the following formula 2, with a compound of the following formula 3, which comprises polyalkyleneglycol with a vinyl group or an allyl group, and a substituted or unsubstituted alkene compound in the presence of a catalyst for hydrosilylation.

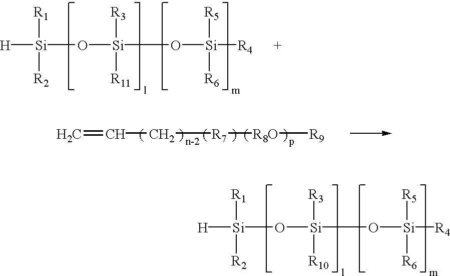

In the above, R₁, R₂, R₃, R₅, R₆, and R₁₀ are the same as defined in the above formula 1. R₁₁ is a hydrogen atom, a methyl group, or a phenyl group.

The examples of compounds represented as the above formula 3 are CH₂═CHCH₂O(CH₂CH₂O)ₚCH₃, CH₂═CHCH₂O(CH(CH₃)CH₂O)ₚCH₃, CH₂═CHCH₂O(CH(CH₃)CH₂O)ₚCH₃, CH₂═CHCH₂O (CH₂CH₂O)ₚC(═O)CH₃, CH₂═CHCH₂O(CH₂CH₂O)ₚC(═O)(CH₂)₈CH₃, CH₂═CHCH₂O(CH₂CH₂O)ₚSO₂CH₃, CH₂═CH—C₆H₄—CH₂O(CH₂CH₂O)ₚCH₃, CH₂═CHCH₂O(CH₂CH₂O)ₚC(═O)CH₃ and the like.

The compounds represented by the above formula 3 can be synthesized by using a known method (Makromol. Chem. 1981, 182, 1379) and they are also commercially available (e.g., Aldrich Co., USA). The methods of their syntheses are disclosed in the following preparation examples 1 and 2.

The modified diene copolymers according to the present invention are manufactured by the reaction between polar polysiloxane of the above formula 1 and a diene copolymer in the presence of a catalyst for hydrosilylation. Examples of catalysts for hydrosilylation that can be used in the present invention are transition metals or complex compounds of these transition metals such as chloroplatinic acid, palladium, rhodium, and platinum. These catalysts for hydrosilylation can be synthesized by using a known method and they are also commercially available. Examples of solvents for reaction include organic solvents such as benzene, toluene, and xylene but they are not limited to these solvents.

The reaction temperature for hydrosilylation ranges from about −20 to about 150° C., preferably between room temperature and 120° C., and the reaction mixture is agitated under nitrogen atmosphere. Reaction time is not specifically restricted and the reaction is performed from about 30 min to about a week. The mixing ratio between a diene copolymer and the modifying agent of the above formula 1 is not particularly limited but it is preferred to be in the range of from 1000:1 to 1:10 in molar ratio, and more preferably in the range of from 1000:1 to 5:1 for better physical properties of a polymer. After the reaction, the solvent is eliminated under reduced pressure and purified and finally modified diene copolymer, the targeted product of the present invention, is manufactured. The modified diene copolymers of the present invention are characterized by having an improved glass transition temperature and mechanical properties.

Examples of diene copolymers used in the modification of the present invention are styrene-butadiene copolymer (block or random, diblock, triblock copolymer, etc.), acrylonitrile-butadiene copolymer, styrene-isoprene copolymer, or a polymer wherein these polymers are partially hydrogenated, epoxidized, brominated, or a mixture of these.

The method of manufacturing styrene-butadiene-styrene block copolymer (PEGPDMS-SBS) substituted with polyethyleneglycol monomethylether (PEGME), as an example of the modified diene copolymers of the present invention, is as follows.

The styrene-butadiene-styrene block copolymer (SBS) is dissolved in toluene in a nitrogen atmosphere, added with a reaction catalyst of 0.1 mL of platinum (0)-1,3-divinyl-1,1,3,3-tetramethylsilane complex (solution in xylenes) and stirred for 10 min, further added with the polyethyleneglycol monomethylether (PEGME)-polydimethylsiloxane (referred to hereinafter as ‘PSI300’) dropwise and the reaction mixture is stirred for 24 hr at room temperature. Then, the above mixture is stirred for 1 hr after adding active carbon, filtered through Celite (Juncei Chemical Co., Japan) and precipitated by adding the reaction mixture to a large amount of methanol. The precipitate is washed several times with methanol and dried in a vacuum oven kept at a room temperature to finally obtain the styrene-butadiene-styrene block copolymer (PEGPDMS-SBS), which is modified with a polar polysiloxane, with more than 90% of yield. Thus obtained modified diene copolymer was shown to have a glass transition temperature 5° C. higher than that of styrene-butadiene-styrene block copolymer (SBS) and had improved mechanical properties.

The present invention also relates to a nanocomposite comprising the aforementioned modified diene copolymer and an inorganic filler. The polar polysiloxane of the above formula 1 used as a modifying agent can improve compatibilities by having an interaction with an inorganic filler such as silica, carbon black, metal oxide, metal powder, glass fiber and ceramic, and thus the diene copolymer of the present invention modified into a polar polysiloxane becomes useful as a composite for an organic-inorganic hybrid.

The nanocomposite of the present invention is prepared by melting the above modified diene copolymer and at least one inorganic filler selected from the group consisting of silica, carbon black, metal powder, metal oxide, layered-silica, glass fiber, and ceramic at 40-300° C. for 1 min to 5 hr. Inorganic filler is used in the range of from 0.1 to 80 wt % relative to that of the modified diene copolymer. The melt processed composition can be added with additives such as an oxidizing agent, a coupling agent, a UV stabilizer, a crosslinking agent, a flame retardant, and the like depending on the objectives of their uses. These additives have been conventionally used in preparing nanocomposites and there are no particular restrictions applied in using these additives.

A preferred embodiment of the present invention to manufacture the nanocomposite of the present invention shows that 40 g of the above prepared modified diene copolymer PEGPDMS-SBS and 2 g of OMMT are added into Brabender preheated to 110° C. and mixed for 10 min to obtain nanocomposites wherein polymer is intercalated into the OMMT. Here, the distance between individual layers of organically modified montmorillonite becomes wider by the range of from 0.3-10 nm than that of OMMT itself, and the manufacture of the nanocomposite was thus confirmed. Melt-mixed samples were inserted into a 2 mm thick mold for compression molding for 15 min at 110° C. by means of a hot press and cooled for 20 min to obtain nanocomposite sheets. These nanocomposites have an increased glass transition temperature by 5° C. and tensile strength, elasticity, weatherability, and the like have been much improved.

The modified diene copolymers of the present invention are well dissolved in organic solvents such as benzene, toluene, and xylene and thus they can be used in manufacturing organic-inorganic nanocomposites by means of solution processing method. That is, the nanocomposites can be manufactured via melt process of a composition by placing it at a temperature of about 200° C. for from 1 min to 5 hr, wherein said composition comprises a modified diene copolymer; at least one inorganic filler selected from silica, carbon black, metal powder, metal oxides, layered-silicate, glass fiber, ceramics, and the like; and at least one solvent selected from benzene, toluene, xylene, tetrahydrofuran, alcohol, ether, and the like.

An inorganic filler is used in the range of 0.1-80 wt % of that of the modified diene copolymer. Additives that can be added in the solution processing composition include an oxidant, a coupling agent, a crosslinking agent, and a flame retardant, and further, other additives can be also added depending on the purpose of use. As described above, these additives have been conventionally used in manufacturing nanocomposites and there are no particular restrictions applied on these additives.

This invention is further illustrated by the following examples, however, these examples should not be construed as limiting the scope of this invention in any manner.

The reagents and solvents required in synthesis of modifiers or in modification of styrene-butadiene-styrene block copolymer were purchased from Aldrich Co., Ltd. (U.S.A.). The OMMT used in the preparation of nanocomposites were purchased from Southern Clay Co., Ltd. (U.S.A.). Silica particle used was Zeosil 165, a product from Rhone-Poulenec Chimie Co., Ltd.(U.S.A.).

The functionality tests of the manufactured products in the Examples were performed according to the following test methods.

[Test Methods]

1. Distance between the layers: measure the distance between the layers of inorganic clay by means of wide angle X-ray scattering (WAXS)

2. Mechanical property: measure the tensile properties (tensile strength, tensile modulus, and elongation at break, etc.) according to ASTM D412

3. Thermal property: measure by means of DSC (Differential Scanning Calorimetry) and TGA (Thermogravimetric Analysis)

4. Thermo.mechanical property: measure by means of DMA (Dynamic Mechanical Analysis)

5. Morphology of nanocomposites: Examined by means of TEM (Transmission Electron Microscopy) after cutting the nanocomposites into thin films at liquid nitrogen temperature by molding them into an epoxy resin.

6. Transmittance: measure transmittance (%) of 2 mm thick specimens at 600 nm

### PREPARATION EXAMPLE 1

### Synthesis of Polyethyleneglycol Monomethylallylether (PEGMAE, Number Average MW of PEG Unit=350)

To a 1000 mL, three-necked round bottom flask, equipped with a magnetic stirrer, a nitrogen gas flow and a condenser, was added 550 mL of distilled tetrahydrofuran with metal sodium and benzophenone. Then, sodium hydride (8.28 g) was added and stirred for 30 min at room temperature followed by the addition of 95.61 g (0.27 ml) of polyethyleneglycol monomethylether (PEGME) with number average MW of 350, which was stirred to result in a suspension. This reaction mixture was then stirred for 2 hr at room temperature and added with a small amount of potassium iodide (KI) and cupric chloride (CuCl₂). The mixture was further added with 35.73 g (0.27 mol) of allylbromide (CH₂=CHCH₂Br) dropwise and stirred for 12 hr at 60° C. Upon completion of the reaction, the reaction mixture was washed three times with water after extraction with methylene chloride, and the organic fraction was dried over magnesium sulfate. After evaporating solvent under reduced pressure, the product was vacuum dried and finally PEGMAE (polymerization degree: 7.2), a colorless liquid, was synthesized.

¹H NMR(300 MHz, CDCl₃) δ 3.33(s, 3H), 3.63(m, H), 4.03(m, 2H), 5.24(m, 2H), 5.90(m, 1H)

### PREPARATION EXAMPLE 2

### Synthesis of Polydimethylsiloxane (PSI300) Substituted with Polyethyleneglycol Monomethylallylether (PEGMAE)

To a 1000 mL, three-necked round bottom flask, equipped with a magnetic stirrer, a nitrogen gas flow and a condenser, were added ⁷4.6 g (12.9 mol) of polydimethylsiloxane (PDMS, hydride terminated, number average MW; 580) and 500 mL of distilled toluene with metal sodium and benzophenone. Upon complete dissolution of PDMS (hydride terminated) in toluene, 0.5 mL of platinum (0)-1,3-divinyl-1,1,3,3-tetramethylsilane complex (solution in xylenes, PTDVT) was added, followed by the further addition of 50.0 g (12.9 mol) of polyethyleneglycol monomethylallylether (PEGMAE) dropwise. This reaction mixture was slowly heated to 60° C. and stirred for 12 hr at the temperature and then cooled down to a room temperature. The mixture was further added with active carbon in order to remove platinum catalyst and stirred for 1 hr, filtrated through Celite, distilled under reduced pressure to remove unreacted substances and finally polydimethylsiloxane (PSI300) substituted with polyethyleneglycol monomethylallylether (PEGMAE) was synthesized.

¹H NMR(300 MHz, CDCl₃) δ 0.04□0.2(m, H), 0.51(m, 1H), 1.58(m, H), 3.38□3.55(m, H), 3.57□3.65(m, H), 4.70(m, 1H)

### PREPARATION EXAMPLE 3

### Synthesis of Triethyleneglycol Monomethylallylether (TEGMAE)

To a 1000 mL, three-necked round bottom flask, equipped with a magnetic stirrer, a nitrogen gas flow and a condenser, was added with 550 mL of distilled tetrahydrofuran with metal sodium and benzophenone. Then, the flask was stirred after further adding 15.6 g of sodium hydroxide and then 55.26 g of 1.5 eq of allylbromide (0.46 mol) was slowly added. This reaction mixture was refluxed for 16 hr and was allowed to cool to room temperature to form the precipitate. The resulting solid was separated by filtration. After removing the solvent of the filtrate under reduced pressure, the crude product was dissolved in methylene chloride and then washed with water three times. After isolating the organic fraction of the resulting reaction mixture, the organic fraction was dried over magnesium sulfate and the solvent was removed under reduced pressure, vacuum dried and then finally triethyleneglycol monomethylallylether (TEGMAE) was synthesized. ₁H NMR(300 MHz, CDCl₃) δ3.33(s, 3H), 3.63(m, H), 4.03(m, 2H), 5.24(m, 2H), 5.90(m, 1H).

### PREPARATION EXAMPLE 4

### Synthesis of Polydimethylsiloxane (PSI012) Substituted with Triethyleneglycol Monomethylallylether (TEGMAE)

Polydimethylsiloxane (PSI012) substituted with triethyleneglycol monomethylallylether (TEGMAE) was synthesized according to the method in the preparation example 2 with the exception that triethyleneglycol monomethylallylether (TEGMAE) prepared according to the method in preparation example 3 was used instead of polyethyleneglycol monomethylallylether (PEGMAE).

¹H NMR(300 MHz, CDCl₃) δ0.04□0.2(m, H), 0.51(m, 1H), 1.58(m, H), 3.38□3.55(m, H), 3.57□3.65(m, H), 4.70(m, 1H)

### PREPARATION EXAMPLE 5

### Synthesis of Polydimethylsiloxane (PSI400) Substituted with Allylethylether (AEE)

Polydimethylsiloxane (PSI400) substituted with allylethylether (AEE) was synthesized according to the method in the preparation example 2 with the exception that allylethylether (AEE) was used instead of polyethyleneglycol monomethylallylether (PEGMAE).

¹H NMR(300 MHz, CDCl₃) δ0.04□0.2(m, H), 0.51(m, 1H), 1.58(m, H), 3.38□3.55(m, H), 3.5703.65(m, H), 4.70(m, 1H)

### EXAMPLE 1

### Synthesis of Diene Copolymers Substituted with Polar Polysiloxane

In a 1000 mL, three-necked round bottom flask, equipped with a magnetic stirrer, a nitrogen gas flow and a condenser, 100 g of styrene-butadiene-styrene block copolymer (SBS copolymer) was dissolved in 1000 mL of purified toluene. The mixture was added with 0.1 mL of platinum (0)-1,3-divinyl-1,1,3,3-tetramethylsilane complex (solution in xylene, PTDVT), a reaction catalyst, and stirred for 10 min. Twelve and 0.52 g of the polar polysiloxane PSI300(1 mol % of butadiene block) synthesized in the preparation example 2 was slowly added to the mixture and stirred for 24 hr at room temperature. The above mixture was stirred for 1 hr after adding active carbon to remove the platinum catalyst, filtered through Celite and precipitated by adding the reaction solution to methanol. The precipitate was washed several times with methanol and dried in a vacuum oven kept at room temperature to finally obtain the styrene-butadiene-styrene block copolymer (PEGPDMS-SBS), which was modified with a polar polysiloxane.

¹H NMR(300 MHz, CDCl₃) δ0.04□0.10(m, H), 1.27□1.56(m, H), 2.03□2.07(m, H), 3.38□3.66(m, H), 4.96□4.99(m, H), 5.38□5.70(m, H), 6.29□6.82(m, H), 6.86□7.22(m, H); GPC (Ps standards): MW=89000, polydispersity 1.17.

In synthesizing modified diene copolymers according to the Example 1, polar polysiloxane, styrene-diene copolymer and reaction conditions were modified as set forth below in order to synthesize styrene-diene copolymer substituted with polar polysiloxane.

SBS: a styrene-butadiene-styrene block copolymer wherein its styrene content is 30 wt % and number MW is about 80,000.

SBR: a polymer wherein styrene and butadiene are randomly bonded.

SEBS: a styrene-butadiene block copolymer wherein its styrene content is 30 wt %, butadiene is partially hydrogenated and its number MW is about 100,000.

TABLE 1

| | Styrene | Polar | | | | | Reaction | |
|---|---|---|---|---|---|---|---|---|
| | diene | polysiloxane, | | | | Reaction | temperature | T_{g} |
| Classification | polymer | mol %¹⁾ | m²⁾ | solvent | catalyst | time (hr) | (° C.) | (° C.) |
| Modified | SBS | Preparation | 9 | toluene | PTDVT | 24 | 25 | −71, |
| copolymer 1 | | Ex. 2, 1 | | | | | | 102 |
| Modified | SBS | Preparation | 7 | toluene | PTDVT | 15 | 25 | −71, |
| copolymer 2 | | Ex. 4, 1 | | | | | | 104 |
| Modified | SBS | Preparation | 7 | toluene | PTDVT | 20 | 25 | −68, |
| copolymer 3 | | Ex. 5, 1 | | | | | | 106 |
| Modified | SBS | Preparation | 50 | toluene | PTDVT | 12 | 25 | −76, |
| copolymer 4 | | Ex. 2, 1 | | | | | | 105 |
| Modified | SBR | Preparation | 7 | toluene | PTDVT | 24 | 25 | −26 |
| copolymer 5 | | Ex. 2, 1 | | | | | | |
| Modified | SBS | Preparation | 9 | toluene | PTDVT | 10 | 75 | −70, |
| copolymer 6 | | Ex. 2, 2 | | | | | | 105 |
| Modified | SBS | Preparation | 9 | toluene | Chloro- | 20 | 30 | −67, |
| copolymer 7 | | Ex. 2, 5 | | | platinic | | | 107 |
| | | | | | acid | | | |
| Modified | SEBS | Preparation | 9 | toluene | PTDVT | 5 | 60 | −72, |
| copolymer 8 | | Ex. 2, 1 | | | | | | 109 |
| Modified | SBS | Polydiphenyl | 10 | toluene | PTDVT | 24 | 60 | −65, |
| copolymer 9 | | siloxane, | | | | | | 110 |
| | | dimethylhydr | | | | | | |
| | | ogensilyl-ter | | | | | | |
| | | minated | | | | | | |
| Modified | SBS | Poly(oxymeth | 15 | toluene | PTDVT | 24 | 25 | −71, |
| copolymer | | ylsilylene), | | | | | | 105 |
| 10 | | α-dimethylsil | | | | | | |
| | | yl-ω-trimethyl | | | | | | |
| | | silyloxy | | | | | | |

¹⁾the amount of use of polar polysiloxane relative to that of diene copolymer
²⁾the average length of polysiloxane which is equal to ‘m’ in formula 1

### EXAMPLE 2

### Synthesis of Elastomer Nanocomposites

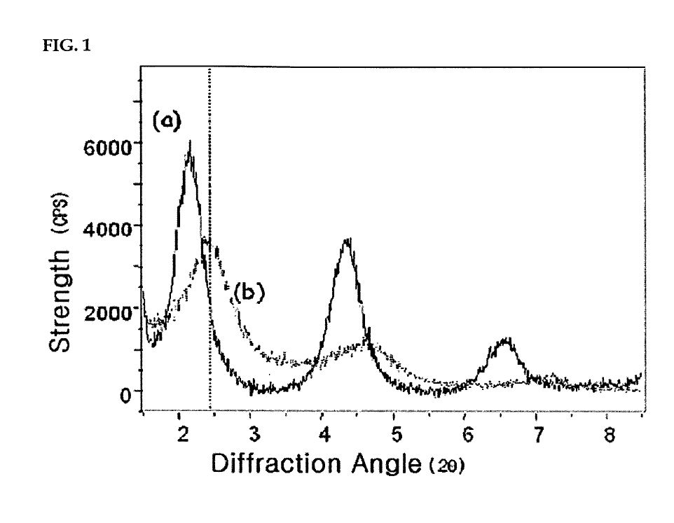

Forty grams of modified diene copolymer PEGPDMS-SBS and 2 g of OMMT (organically modified montmorillonite, Southern Clay Co., Ltd., U.S.A.; model 6A) were inserted into Brabender preheated to 110° C. and mixed for 10 min. Melt mixed samples were inserted into a 2 mm thick mold for compression molding for 15 min at 110° C. by means of a press and cooled down for 20 min to obtain nanocomposite sheets. Thus obtained PEGPDMS-SBS/OMMT nanocomposites had 37 MPa of tensile strength, 1150% of elongation at break, and the distance between layers of OMMT became wider to be 4.1 nm as shown in FIG. 1.

In manufacturing nanocomposites according to example 2, a modified diene copolymer, an inorganic filler and manufacturing conditions were modified as shown in the following table 2 and the results are shown in the following table 3.

TABLE 2

| | | Inorganic | Tem- | | Other |
|---|---|---|---|---|---|
| | Modified diene | filler | perature | Time | additives |
| Classification | copolymer | (wt %^{a)}) | (° C.) | (min) | (wt %) |
| Composite 1 | Copolymer 1 | 6A^{b)}(5) | 100 | 10 | — |
| Composite 2 | Copolymer 1 | Silica(5) | 100 | 10 | Irganox |
| | | | | | (0.2) |
| Composite 3 | Copolymer 1 | 6A(5) | 110 | 10 | — |
| Composite 4 | Copolymer 1 | 25A^{c)}(5) | | 10 | — |
| Composite 5 | Copolymer 1 | DC-PSiO- | 110 | 10 | — |
| | | MMT^{d)}(5) | | | |
| Composite 6 | Copolymer 5 | 6A(5) | 110 | 10 | — |
| Composite 7 | Copolymer 2 | 6A(5) | 110 | 10 | — |
| Composite 8 | Copolymer 6 | 6A(5) | 110 | 10 | — |
| Composite 9 | Copolymer 7 | 6A(5) | 150 | 10 | — |
| Composite 10 | Copolymer 7 | Carbon | 110 | 15 | Irganox |
| | | black (2) | | | (0.2) |
| Composite 11 | Copolymer 2 | 6A(5) | 100 | 10 | Irganox |
| | | | | | (0.2) PS |
| | | | | | (5)^{e)} |
| Composite 12 | Copolymer 9 | 6A(5) | 130 | 10 | — |
| Composite 13 | Copolymer 10 | 6A(5) | 100 | 10 | — |

^{a)}the amount of use of inorganic filler relative to that of modified diene copolymer
^{b)} & ^{c)}: model names of montmorillonite
^{d)}OMMT which contains a polysiloxane group substituted with decanoyl chloride
^{e)}polystyrene having a MW of 20,000

TABLE 3

| | | | | Distance between | |
|---|---|---|---|---|---|
| | | | | layers of OMMT or | |
| | Young's | Tensile | | average dispersion | |
| | Modulus | strength | Elongation | degree of inorganic | Transmittance |
| Classification | (MPa) | (MPa) | at break (%) | particles (nm) | (%) |
| Composite 1 | 6.3 | 37 | 1150 | 4.1 | 70 |
| Composite 2 | 6.2 | 37 | 1200 | 200 | 75 |
| Composite 3 | 6.2 | 36 | 1100 | 4.1 | 83 |
| Composite 4 | 4.5 | 15 | 1000 | 3.7 | 80 |
| Composite 5 | 4.6 | 18 | 1240 | >10 | 40 |
| Composite 6 | — | — | — | 4.3 | 82 |
| Composite 7 | 6.4 | 36 | 1100 | 4.2 | 84 |
| Composite 8 | 6.1 | 29 | 900 | 4.5 | 86 |
| Composite 9 | 5.1 | 27 | 700 | >10 | 84 |
| Composite 10 | 5.9 | 30 | 9500 | 200 | 10 |
| Composite 11 | 6.5 | 39 | 1250 | >10 | 85 |
| Composite 12 | 6.0 | 38 | 950 | 3.5 | 70 |
| Composite 13 | 5.5 | 35 | 1050 | 3.0 | 73 |

TABLE 4

| | | | | | | Distance between |
|---|---|---|---|---|---|---|
| | | | | | | layers of OMMT or |
| | Styrene- | Inorganic | Young's | Tensile | Elongation | average dispersion |
| | diene | filler | Modulus | strength | at break | degree of inorganic |
| Classification | polymer¹⁾ | (wt %²⁾) | (MPa) | (MPa) | (%) | particles (nm) |
| Comparative | SBS | — | 5.0 | 20 | 920 | — |
| composite 1 | | | | | | |
| Comparative | SBS | 6A (5) | 6.01 | 26 | 1100 | 3.8 |
| composite 2 | | | | | | |
| Comparative | SBR | Silica (30) | — | — | — | 1000 |
| composite 3 | | | | | | |

¹⁾styrene-diene copolymer which is not substituted with polysiloxane
²⁾the amount of use relative to that of a polymer

As shown above, the modified diene copolymer of the present invention is the one substituted with polar polysiloxane and has excellent mechanical property, thermal stability, solubility in organic solvents and thus can be applied to various structural materials, coating agents, modifiers, thickeners, adhesives, and the like. Further, organic-inorganic hybrid composites can be manufactured by mixing the modified diene copolymer of the present invention and inorganic filler followed by a solution process or a melt process. Particularly, the modified diene copolymers of the present invention have an excellent affinity for layered-silicate and are thus useful for manufacturing functional nanocomposite powder with improved heat stability and mechanical property.

What is claimed is:

1. A modified diene copolymer wherein a diene copolymer is substituted with polar polysiloxane of the following formula 1, 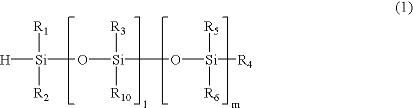
wherein R₁, R₂, R₃, R₅ and R₆ are independently the same or different substitution group of a methyl group or a phenyl group; R₄ is —(CH₂)ₙ—(R₇)—(R₈O)ₚ—R₉; R₇ represents a bond, —O—, a substituted or unsubstituted alkylene group of C₁-C₅ or a benzene ring; R₈ is —(CH₂)₂— or —CH(CH₃)CH₂—, R₉ represents a substituted or unsubstituted alkyl group of C₁-C₂₀, a halogen atom, —COCH₃ or —SO₂CH₃; R₁₀ is the same as R₄ or a methyl group or a phenyl group; l is an integer of 0-50; m is an integer of 1-500; n is an integer of 2-5; and p is an integer of 0-100.

2. The modified diene copolymer according to claim 1, wherein said diene copolymer is selected from the group consisting of styrene-butadiene copolymer, acrylonitrile-butadiene copolymer, styrene-isoprene copolymer, or a polymer wherein these polymers are partially hydrogenated, epoxidized, brominated, or a mixture of these.

3. A method for manufacturing a diene copolymer substituted with polar polysiloxane of the following formula 1 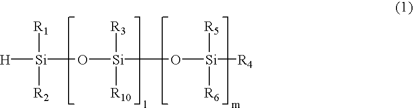
wherein said diene copolymer undergoes hydrosilylation at the range of from −20° C. to 150° C. in the presence of a catalyst for hydrosilylation selected from the group consisting of polar polysiloxane of the following formula 1, transition metal and a complex compound of transition metal.

4. A nanocomposite composition comprising said modified diene copolymer of claim 1 and at least one inorganic filler selected from the group consisting of silica, carbon black, metal powder, metal oxide, layered-silicate, glass fiber and ceramic.

5. The nanocomposite composition according to claim 4, wherein said composition further comprises a conventional additive selected from a group consisting of an oxidizing agent, a coupling agent, a UV stabilizer, a cross-linking agent, a flame-retardant, and an organic solvent.
